(19) United States
(12) Patent Application Publication
(10) Pub. No.: US 2012/0011962 A1
(43) Pub. Date: Jan. 19, 2012

(54) GEAR WITH MULTIPLE MAGNETIC TOOTH ENGAGEMENT

(75) Inventor: William R. Richards, Springfield, VA (US)

(73) Assignee: MAGNETIC TORQUE INTERNATIONAL LTD., RESTON (VA)

(21) Appl. No.: 12/593,822

(22) PCT Filed: Apr. 2, 2008
(86) PCT No.: PCT/US08/04279

§ 371 Date: Jun. 29, 2011

Related U.S. Application Data
(60) Provisional application No. 60/907,435, filed on Apr. 2, 2007.

(51) Int. Cl. F16H 49/00

(52) U.S. Cl. 74/640

(57) ABSTRACT

A magnetic gear system is provided. The system has a first disk having a first axis and a plurality of first magnets; and a second disk having a second axis and a plurality of second magnets. The first and second axes are not collinear, and magnetic interactions between multiple ones of the first magnets and multiple ones of the second magnets cause the second disk to rotate when the first disk is rotated.

### BACKGROUND OF THE INVENTION

This application claims the benefit of U.S. Provisional Patent Application No. 60/907,435, filed Apr. 2, 2007, the content of which is incorporated herein by reference in its entirety.

### FIELD OF THE INVENTION

The invention relates to gear systems and, more particularly, to systems and methods of using magnetic tooth engagement.

### DISCUSSION OF THE RELATED ART

In general, transmission of rotational motion is accomplished by coupling rotating shafts using a combination of physically connected members. For example, in order to transfer rotational motion from a first rotational shaft to a second rotational shaft, either gears, belts, or chains are commonly used. However, due to mechanical friction between the physically connected members, significant amounts of heat are generated that causes premature failures of the physically connected members and increases costs and loss of productivity due to repairs. Moreover, although the mechanical friction may be reduced by supplying a lubricant to the physically connected members, operational speed of the physically connected members has a maximum upper limit, thereby severely limiting transfer of the rotational motion between the first and second rotational shafts.

In addition, using physically connected members produces losses in the form of, for example, heat, noise and vibration. Furthermore, precise alignment of the shafts in a physically connected system must be maintained at all times in order to minimize these loses.

### SUMMARY OF THE INVENTION

Accordingly, the invention is directed to a magnetic gear system having multiple magnetic tooth engagement.

Particular embodiments of the invention provide a magnetic gear system. The system has a first disk having a first axis and a plurality of first magnets; and a second disk having a second axis and a plurality of second magnets. The first and second axes are not collinear, and magnetic interactions between multiple ones of the first magnets and multiple ones of the second magnets cause the second disk to rotate when the first disk is rotated.

Other embodiments of the invention provide a method of transferring rotation with a magnetic gear system. The method includes rotating a first disk having a plurality of first magnets around a first axis; and causing a second disk having a second axis and a plurality of second magnets to rotate due to magnetic interactions between multiple ones of the first magnets and multiple ones of the second magnets when the first disk is rotated. The first and second axes are not collinear.

Additional features and advantages of the invention will be set forth in the description which follows, and in part will be apparent from the description, or may be learned by practice of the invention. The objectives and other advantages of the invention will be realized and attained by the structure particularly pointed out herein.

It is to be understood that both the foregoing general description and the following detailed description are exemplary and explanatory and are intended to provide further explanation of the invention.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain principles of the invention. In the drawings:

FIG. 1 is a side view of a first disk of a first embodiment of the invention;

FIG. 2 is a side view of a second disk of the first embodiment of the invention;

FIG. 3 is a side view of the first embodiment of the invention;

FIG. 4 is a top view of the embodiment shown in FIG. 3;

FIG. 5 is a side view of a second embodiment of the invention;

FIG. 6 is a sectional view taken along section line VI-VI in FIG. 5;

FIG. 7 is a top view of a third embodiment of the invention; and

FIG. 8 is a top view of a fourth embodiment of the invention.

### DETAILED DESCRIPTION OF EXPEMPLARY EMBODIMENTS OF THE INVENTION

Reference will now be made in detail to particular embodiments of the invention, examples of which are illustrated in the accompanying drawings.

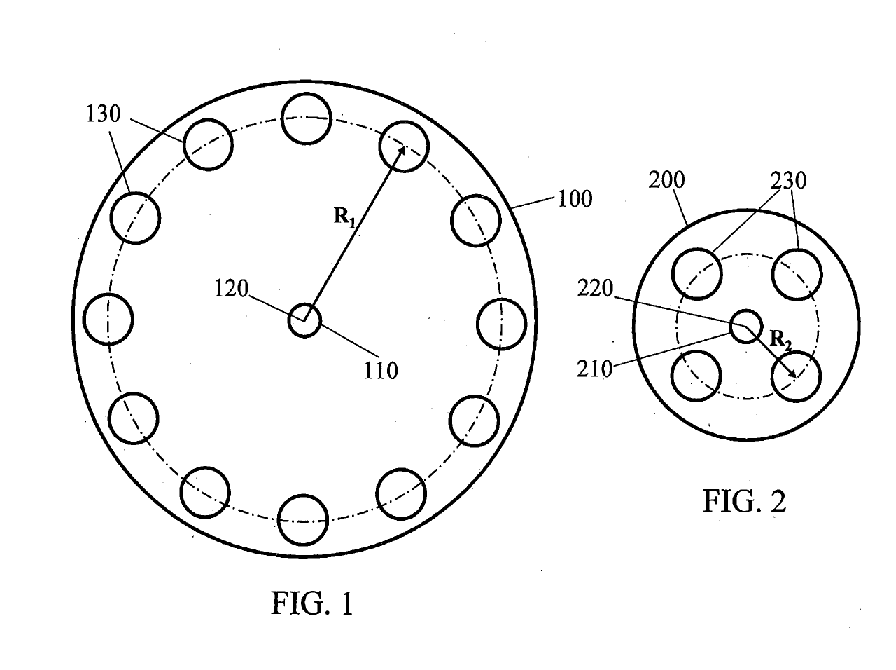

FIG. 1 is aside view of a first disk 100 in accordance with an example of the invention. First disk 100 rotates around a first axis 120 and has a plurality of first magnets 130 located, in this example, at a radius R1 from the first axis 120. First disk 100 is attached to a first shaft 110.

FIG. 2 is a side view of a second disk in accordance with an example of the invention. Second disk 200 rotates around a second axis 220 and has a plurality of second magnets 230 located, in this example, at a radius R2 from the second axis 220. Second disk 200 is attached to a second shaft 210.

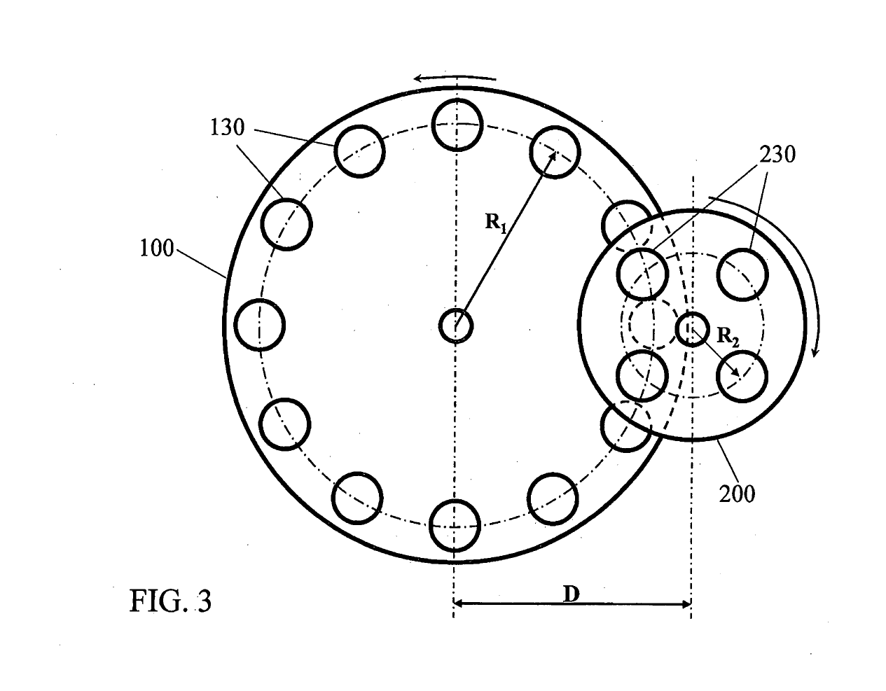

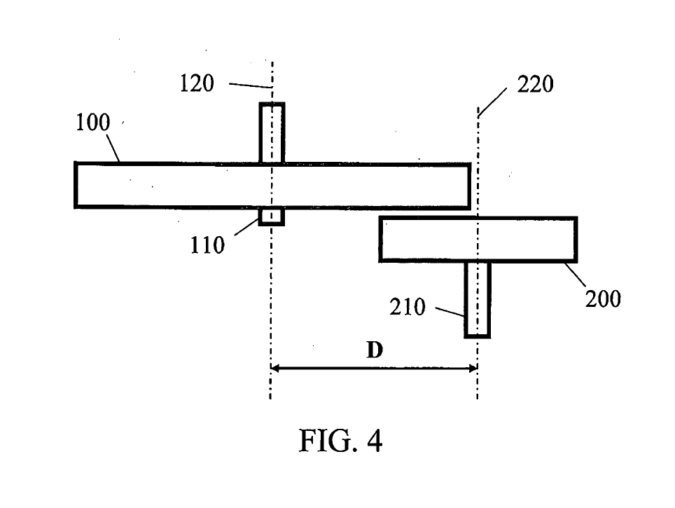

FIG. 3 shows an example of how first disk 100 and second disk 200 can be positioned relative to each other to provide a gear set in accordance with the invention. In FIG. 3, second disk 200 overlaps first disk 100 so that multiple ones of second magnets 230 engage multiple ones of first magnets 130. This engagement of multiple magnets will be referred to as the engagement of multiple magnetic teeth. FIG. 4 is a top view of the example shown in FIG. 3.

In the example shown in FIGS. 3 and 4, first axis 120 and second axis 220 are positioned a distance D apart. In order to provide the multiple magnetic tooth engagement that is desirable, D should be smaller than the sum of R1 and R2.

By positioning the first and second axes such that they are not collinear allows R1 and R2 to be different. By changing the ratio of R1 to R2, the relative rotational velocities of first shaft 110 and second shaft 120 (the gear ratio) can be changed. This is analogous to changing the relative size of two conventional toothed mechanical gears in a gear set. Changing the number of first magnets 130 relative to the number of second magnets 230 can change the gear ratio of the gear set as long as the number of both magnets is sufficient to provide proper and consistent engagement of the magnetic “teeth”.

The magnets may be positioned such that they act in attractive mode or repulsive mode. If used in attractive mode, very high torque ripple may result. However, if used in repulsive mode, and by employing the configurations of the invention, a shear force equivalent to four times the shear force achieved from a single interaction between two magnets is achieved. This configuration also provides a gear tooth mesh ratio of at least twice that of any known mechanical gear system.

In the invention, the magnetic shear forces acting on the cross sectional areas of the magnets themselves yield compressive stresses that are orders of magnitude less than those existing in any known form of mechanical gear train.

By using magnetic gears instead of mechanical gears, contact between the gears is eliminated, resulting in no wear and no noise. In addition, the need for lubricating the gears themselves is eliminated. This form of speed changing device (as a speed increaser or a speed decreaser) can transmit torque speed at greater than 99.5% efficiency. Consequently, there is no need for any form of heat dissipation for indefinite periods of operation.

Gear box reliability is limited only by the B10 life of bearings on the main shaft elements. By assuring that basic static capacity is approximately five times greater than design loads, operational life times can exceed 20 years or more.

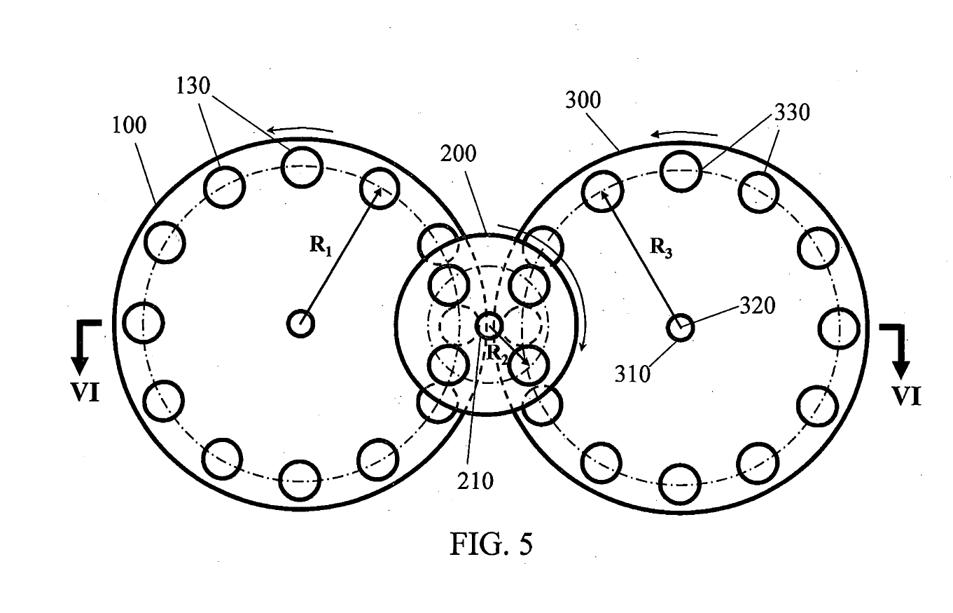

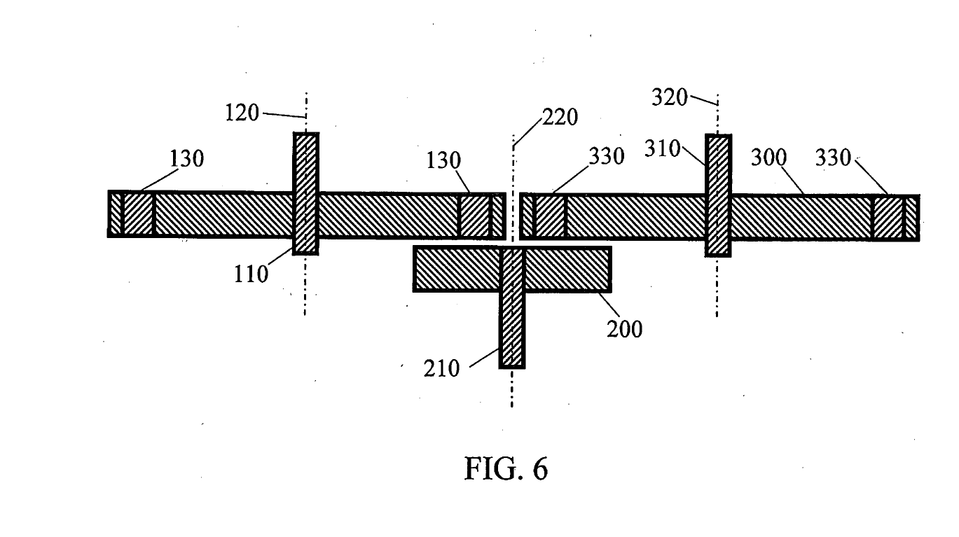

FIGS. 5 and 6 show an example of another embodiment of the invention in which two disks engage second disk 200. Third disk 300 rotates around third axis 320 and has a shaft 310. Third disk 300 has a plurality of third magnets 330 that engage second magnets 230 of second disk 200. Third magnets 330 are located at a third radius R3 from third axis 320. This embodiment provides twice the torque transfer that is provided by the system shown in FIGS. 3 and 4. Multiple systems such as these can be provided to further increase the torque handling ability of the overall gear set. For example, a second disk 200 can be added to the system shown in FIGS. 5 and 6 such that the two disks 200 sandwich (without touching) disks 100 and 300. Additional disks similar to first disk 100, second disk 200 and third disk 300 can be added to even further increase the torque handling capability of the overall gear set.

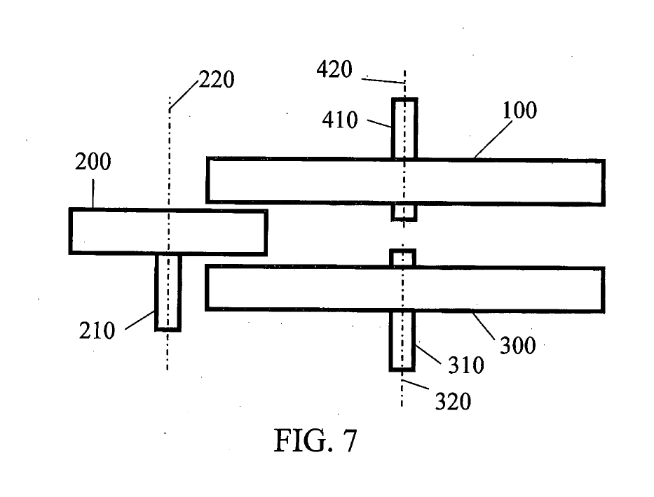

FIG. 7 is a top view of a system similar to the system shown in FIGS. 3 and 4, but includes a fourth disk 400. In this example, third disk 300 and fourth disk 400 are positioned on opposite sides of second disk 200. Fourth disk 400 rotates around a fourth axis 420 and has a shaft 410. A plurality of fourth magnets (not shown) are position in fourth disk 400 similarly to third magnets 330 in third disk 300. In this example, third axis 320 and fourth axis 420 may be collinear or not collinear. In addition, third disk 300 and fourth disk 400 can be the same diameter or different diameters. Further, the location and number of magnets in third disk 300 and fourth disk 400 can be the same or different.

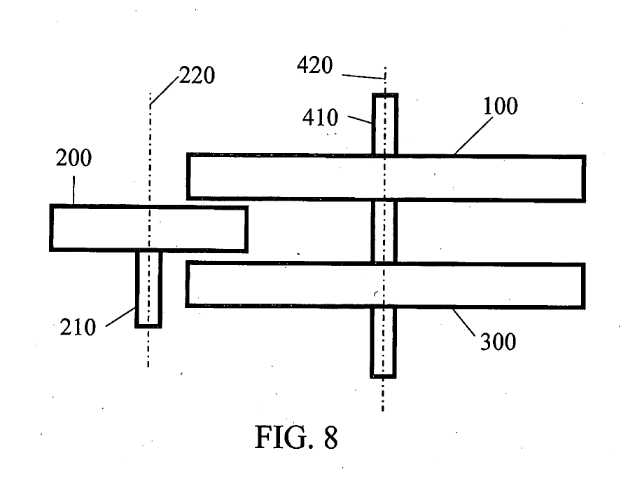

FIG. 8 shows a system similar to the system shown in FIG. 7, but in FIG. 8 third disk 300 and fourth disk 400 are fixed to the same shaft 410 and rotate around the same axis 420.

It will be apparent from this disclosure that multiple combinations of the system shown in FIG. 6 and the system shown in FIG. 8 can result in a gear set having many disks and being capable to transmitting large amounts of torque. In addition, very large gear ratios can be achieved by connecting several systems in series.

It will be apparent to those skilled in the art that various modifications and variations can be made in the systems and methods of the invention without departing from the spirit or scope of the invention. Thus, it is intended that the invention cover these modifications and variations.

1. A magnetic gear system, comprising:
a first disk having a first axis and a plurality of first magnets; and
a second disk having a second axis and a plurality of second magnets,
wherein the first and second axes are not collinear, and
magnetic interactions between multiple ones of the first magnets and multiple ones of the second magnets cause the second disk to rotate when the first disk is rotated.

2. The system of claim 1, further comprising a third disk having a plurality of third magnets,
wherein magnetic interactions between multiple ones of the second magnets and multiple ones of the third magnets cause the second disk to rotate when the third disk is rotated.

3. The system of claim 2, wherein the first disk and the third disk rotate about the first axis.

4. The system of claim 3 wherein the third disk is fixed to the first disk such that the first and third disks rotate together at a first rotational velocity.

5. The system of claim 1, wherein the plurality of first magnets are positioned at a first distance R1 from the first axis, and
the plurality of second magnets are positioned at a second distance R2 from the second axis.

6. The system of claim 5, wherein the sum of R1 and R2 is greater than a distance D1 between the first axis and the second axis.

7. The system of claim 6, wherein the first axis is substantially parallel to the second axis.

8. The system of claim 5, wherein the first axis is substantially parallel to the second axis.

9. The system of claim 2, wherein the third and first axes are not collinear, and the second and first axes are not collinear.

10. The system of claim 9, wherein the first, second and third axes are substantially parallel.

11. A method of transferring rotation with a magnetic gear system, the method comprising:
rotating a first disk having a plurality of first magnets around a first axis; and
causing a second disk having a second axis and a plurality of second magnets to rotate due to magnetic interactions between multiple ones of the first magnets and multiple ones of the second magnets when the first disk is rotated,
wherein the first and second axes are not collinear.

12. The method of claim 11, further comprising
rotating a third disk having a plurality of third magnets, and
causing the second disk to rotate due to magnetic interactions between multiple ones of the third magnets and multiple ones of the second magnets when the third disk is rotated.

13. The method of claim 12, wherein the first disk and the third disk rotate about the first axis.

14. The method of claim 13 wherein the third disk is fixed to the first disk such that the first and third disks rotate together at a first rotational velocity.

15. The method of claim 11, wherein the plurality of first magnets are positioned at a first distance R1 from the first axis, and
the plurality of second magnets are positioned at a second distance R2 from the second axis.

16. The method of claim 15, wherein the sum of R1 and R2 is greater than a distance D1 between the first axis and the second axis.

17. The method of claim 16, wherein the first axis is substantially parallel to the second axis.

18. The method of claim 15, wherein the first axis is substantially parallel to the second axis.

19. The method of claim 12, wherein the third and first axes are not collinear, and the second and first axes are not co-linear.

20. The method of claim 19, wherein the first, second and third axes are substantially parallel.
